(19) United States
(12) Patent Application Publication
(10) Pub. No.: US 2025/0234149 A1
(43) Pub. Date: Jul. 17, 2025

(54) SIGNAL PROCESSING SYSTEM, SIGNAL PROCESSING METHOD, AND NON-TRANSITORY COMPUTER READABLE MEDIUM

(71) Applicant: CLEPSEADRA, INC., Tokyo (JP)

(72) Inventors: Homare KON, Tokyo (JP); Yu MAENO, Tokyo (JP)

(73) Assignee: CLEPSEADRA, INC., Tokyo (JP)

(21) Appl. No.: 18/848,973

(22) PCT Filed: Mar. 20, 2023
(86) PCT No.: PCT/JP2023/010974

§ 371 Date: Sep. 20, 2024

(30) Foreign Application Priority Data
Mar. 25, 2022 (JP) 2022-049883

(51) Int. Cl. H04S 7/00; H04R 5/027; H04R 5/033; H04S 3/00

(52) U.S. Cl. CPC H04S 7/30; H04R 5/027; H04R 5/033; H04S 3/008; H04S 2400/01; H04S 2400/15

(57) ABSTRACT

A signal processing system including a first control unit configured to calculate a transfer characteristic corresponding to a difference between a first audio signal and a second audio signal that is acquired by a first acquisition unit, the first acquisition unit being configured to acquire an audio signal, the second audio signal corresponding to the first audio signal that is reproduced by a first reproduction unit, the first reproduction unit being configured to reproduce an audio signal, and generate a fourth audio signal by convolving an inverse characteristic of the calculated transfer characteristic with a third audio signal that is acquired by a second acquisition unit.

### TECHNICAL FIELD

The present disclosure relates to a signal processing system, a signal processing method, and a program.

### BACKGROUND ART

In recent years, binaural recording has attracted attention. The binaural recording is a technique of recording sounds transmitted to the eardrums of both ears of a human. For example, mics installed in the external auditory canals of both ears are used for binaural recording. The reproduction of binaurally recorded sounds is also referred to as binaural reproduction. Binaural reproduction with earphones, headphones, or the like makes it possible to reproduce stereophonic and realistic sounds that make a listener feel as if the listener was present in the place of recording.

A variety of technologies related to binaural recording and binaural reproduction have been developed. For example, Patent Literature 1 below proposes a binaural recording device including mics for noise cancellation provided outside earphones held on ears by inserting earpieces to the external auditory canals.

### CITATION LIST

### Patent Literature

Patent Literature 1: JP 2009-49947A

### SUMMARY OF INVENTION

### Technical Problem

It has not, however, been so long since the development of the technology described in Patent Literature 1 above, leaving room for improvement from various perspectives.

Accordingly, the present disclosure has been devised in view of the problems described above. An object of the present disclosure is to provide a mechanism that allows the quality of binaural reproduction to further increase.

### Solution to Problem

To solve the above described problem, according to an aspect of the present disclosure, there is provided a signal processing system including a first control unit configured to calculate a transfer characteristic corresponding to a difference between a first audio signal and a second audio signal that is acquired by a first acquisition unit, the first acquisition unit being configured to acquire an audio signal, the second audio signal corresponding to the first audio signal that is reproduced by a first reproduction unit, the first reproduction unit being configured to reproduce an audio signal, and generate a fourth audio signal by convolving an inverse characteristic of the calculated transfer characteristic with a third audio signal that is acquired by a second acquisition unit.

The first control unit may cause a storage unit to store the generated fourth audio signal.

The signal processing system may further include a second control unit configured to cause a second reproduction unit to reproduce the fourth audio signal stored by the storage unit, the second reproduction unit being configured to reproduce an audio signal.

The first control unit may generate a fifth audio signal by convolving a characteristic of the first reproduction unit and an inverse characteristic of a characteristic of a second reproduction unit with the fourth audio signal, the second reproduction unit being configured to reproduce an audio signal.

The first control unit may cause a storage unit to store the generated fifth audio signal.

The signal processing system may further include a second control unit configured to cause the second reproduction unit to reproduce the fifth audio signal stored by the storage unit.

The first control unit and the second control unit may be mounted on different devices.

The first acquisition unit may be disposed near an eardrum of a first user, the first reproduction unit may be disposed at an auricle of the first user, and the second reproduction unit may be disposed at an auricle of a second user different from the first user.

The second reproduction unit may be different from the first reproduction unit.

The second acquisition unit may be disposed near the eardrum of the first user.

To solve the above described problem, according to another aspect of the present disclosure, there is provided a signal processing method including: reproducing a first audio signal by a first reproduction unit configured to reproduce an audio signal; acquiring a second audio signal by a first acquisition unit configured to acquire an audio signal, the second audio signal corresponding to the first audio signal that is reproduced by the first reproduction unit; calculating a transfer characteristic corresponding to a difference between the first audio signal and the second audio signal: acquiring a third audio signal by a second acquisition unit; and generating a fourth audio signal by convolving an inverse characteristic of the transfer characteristic with the third audio signal.

To solve the above described problem, according to another aspect of the present disclosure, there is provided a program for causing a computer to function as a first control unit configured to calculate a transfer characteristic corresponding to a difference between a first audio signal and a second audio signal that is acquired by a first acquisition unit, the first acquisition unit being configured to acquire an audio signal, the second audio signal corresponding to the first audio signal that is reproduced by a first reproduction unit, the first reproduction unit being configured to reproduce an audio signal, and generate a fourth audio signal by convolving an inverse characteristic of the calculated transfer characteristic with a third audio signal that is acquired by a second acquisition unit.

### Advantageous Effects of Invention

As described above, according to the present disclosure, there is provided a mechanism that allows the quality of binaural reproduction to further increase.

### BRIEF DESCRIPTION OF DRAWINGS

FIG. 1 is a block diagram illustrating an example of a configuration of a signal processing system according an embodiment of the present disclosure.

FIG. 2 is a diagram for describing measurement of a transfer characteristic according to the present embodiment.

FIG. 3 is a diagram for describing binaural recording according to the present embodiment.

FIG. 4 is a diagram for describing binaural reproduction according to the present embodiment.

FIG. 5 is a sequence diagram illustrating an example of a flow of processing related to the measurement of the transfer characteristic executed by the signal processing system according to the present embodiment.

FIG. 6 is a sequence diagram illustrating an example of a flow of processing related to binaural recording and binaural reproduction executed by the signal processing system according to the present embodiment.

FIG. 7 is a sequence diagram illustrating an example of a flow of processing related to binaural recording and binaural reproduction executed by a signal processing system according to a first modification example.

FIG. 8 is a diagram schematically illustrating an example of a hardware configuration of a measurement earphone and a mic.

FIG. 9 is a diagram illustrating another example of the configuration of the signal processing system.

FIG. 10 is a diagram illustrating another example of the configuration of the signal processing system.

### DESCRIPTION OF EMBODIMENTS

Hereinafter, referring to the appended drawings, preferred embodiments of the present disclosure will be described in detail. It should be noted that, in this specification and the appended drawings, structural elements that have substantially the same function and structure are denoted with the same reference numerals, and repeated explanation thereof is omitted.

### 1. Configuration Example

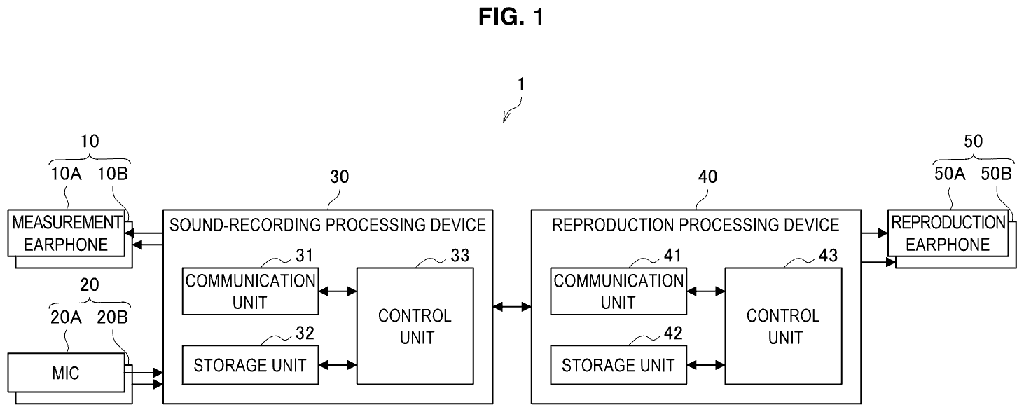

FIG. 1 is a block diagram illustrating an example of a configuration of a signal processing system 1 according an embodiment of the present disclosure. As illustrated in FIG. 1, the signal processing system 1 according to the present embodiment includes measurement earphones 10 (10A and 10B), mics (microphones) 20 (20A and 20B), a sound-recording processing device 30, a reproduction processing device 40, and reproduction earphones 50 (50A and 50B). The signal processing system 1 includes the two measurement earphones 10, the two mics 20, and the two reproduction earphones 50 for both respective ears.

### -Measurement Earphones 10

Each of the measurement earphones 10 is a sound output device that reproduces an audio signal. The measurement earphone 10 converts an inputted audio signal to sound and emits the sound to the surrounding space. The measurement earphone 10 may be connected to the sound-recording processing device 30 through a variety of devices such as a DAC (Digital Analog Converter) and an amplifier that are each related to the reproduction of an audio signal. The measurement earphone 10 is used for the measurement of transfer characteristics described below. The measurement earphone 10 is an example of a first reproduction unit according to the present embodiment. The first reproduction unit may include any sound output device such as a speaker in addition to an earphone.

### -Mics 20

Each of the mics 20 is a sound input device that acquires an audio signal. Each of the mics 20 converts sound in the surrounding space to an audio signal and outputs the converted audio signal. The mic 20 may be connected to the sound-recording processing device 30 through a variety of devices such as an ADC (Analog Digital Converter) and an amplifier that are each related to the acquisition of an audio signal. The mics 20 are used for the measurement of transfer characteristics and binaural recording. Each of the mics 20 may be configured as any type of sound input device such as a dynamic mic, a MEMS (Micro Electro Mechanical Systems) mic, a capacitor mic, or a laser mic. It should be noted that a so-called electret capacitor mic including an electret element for a diaphragm, a back electrode, or a back chamber may be used as the capacitor mic in addition to a type of mic in which a diaphragm receives a direct-current voltage from the outside.

Here, the mics 20 are examples of first acquisition units and second acquisition units according to the present embodiment. The first acquisition units are sound input devices each used for the measurement of transfer characteristics. The second acquisition units are sound input devices used for binaural recording. That is, in the present embodiment, the same mics 20 are used for both the measurement of transfer characteristics and binaural recording.

### -Sound-Recording Processing Device 30

The sound-recording processing device 30 is a signal processing device that performs various kinds of processing related to the measurement of transfer characteristics and binaural recording. The sound-recording processing device 30 may be implemented, for example, by any device such as a PC (Personal computer) or a smartphone. As illustrated in FIG. 1, the sound-recording processing device 30 includes a communication unit 31, a storage unit 32, and a control unit 33.

The communication unit 31 is a communication interface that communicates with another device in a wired or wireless manner. The communication unit 31 performs communication compliant with any communication standard. Examples of the communication standard include Wi-Fi (registered trademark), Bluetooth (registered trademark), or USB (Universal Serial Bus). For example, the communication unit 31 may communicate with the reproduction processing device 40 through the Internet or the like. The communication unit 31 is also an audio interface. The communication unit 31 transmits and receives audio signals to and from the measurement earphones 10 or the mics 20.

The storage unit 32 stores various kinds of information. The storage unit 32 stores data in a predetermined storage medium and reads out data from the predetermined storage medium. Examples of the predetermined storage medium include a non-volatile storage medium such as a flash memory.

The control unit 33 functions as an arithmetic processing device and controls an overall operation of the sound-recording processing device 30 in accordance with a variety of programs. The control unit 33 is implemented, for example, by an electronic circuit such as a CPU (Central Processing Unit) or a DSP (Digital Signal Processor). It should be noted that the control unit 33 may include a ROM (Read Only Memory) that stores a program, an operation parameter, and the like to be used and a RAM (Random Access Memory) that temporarily stores a parameter and the like which appropriately change.

In particular, the control unit 33 performs various kinds of signal processing related to the measurement of transfer characteristics and binaural recording. The control unit 33 is an example of a first control unit according to the present embodiment.

### -Reproduction Processing Device 40

The reproduction processing device 40 is a signal processing device that performs various kinds of processing related to binaural reproduction. The reproduction processing device 40 may be implemented, for example, by any device such as a PC (Personal computer) or a smartphone. As illustrated in FIG. 1, the reproduction processing device 40 includes a communication unit 41, a storage unit 42, and a control unit 43.

The communication unit 41 is a communication interface that communicates with another device in a wired or wireless manner. The communication unit 41 performs communication compliant with any communication standard. Examples of the communication standard include Wi-Fi (registered trademark), Bluetooth (registered trademark), or USB (Universal Serial Bus). For example, the communication unit 41 may communicate with the sound-recording processing device 30 through the Internet or the like. The communication unit 41 is also an audio interface. The communication unit 41 transmits and receives audio signals to and from the reproduction earphones 50.

The storage unit 42 stores various kinds of information. The storage unit 42 stores data in a predetermined storage medium and reads out data from the predetermined storage medium. Examples of the predetermined storage medium include a non-volatile storage medium such as a flash memory.

The control unit 43 functions as an arithmetic processing device and controls an overall operation of the reproduction processing device 40 in accordance with a variety of programs. The control unit 43 is implemented, for example, by an electronic circuit such as a CPU (Central Processing Unit) or a DSP (Digital Signal Processor). It should be noted that the control unit 43 may include a ROM (Read Only Memory) that stores a program, an operation parameter, and the like to be used and a RAM (Random Access Memory) that temporarily stores a parameter and the like which appropriately change.

In particular, the control unit 43 performs various kinds of signal processing related to binaural reproduction. The control unit 43 is an example of a second control unit according to the present embodiment.

### -Reproduction Earphones 50

Each of the reproduction earphones 50 is a sound output device that reproduces an audio signal. The reproduction earphone 50 converts an inputted audio signal to sound and emits the sound to the surrounding space. The reproduction earphone 50 may be connected to the reproduction processing device 40 through a variety of devices such as a DAC (Digital Analog Converter) and an amplifier that are each related to the reproduction of an audio signal. The reproduction earphones 50 are used for binaural reproduction. The reproduction earphone 50 is an example of a second reproduction unit according to the present embodiment. The second reproduction unit may include any sound output device such as a speaker in addition to an earphone.

### 2. Technical Features

### (1) Measurement of Transfer Characteristics

The sound-recording processing device 30 measures transfer characteristics. Transfer characteristics are measured with the measurement earphones 10 and the mics 20 worn on a human user. The transfer characteristics here are the audio characteristics of the transfer paths from the measurement earphones 10 to the mics 20. The acoustic characteristics may be frequency characteristics.

Each of the mics 20 is disposed near an eardrum of a user. Meanwhile, each of the measurement earphones 10 is disposed at the auricle of the user. This configuration makes it possible to measure the acoustic characteristics of the auricle that have great influence on the way in which sound is transmitted to the eardrum. As an example, the mic 20 may be disposed at an external auditory canal and the measurement earphone 10 may be disposed at a cavum concha. The user who wears the measurement earphones 10 and the mics 20 to measure the transfer characteristics will be referred to as a user A below. The user A is an example of a first user according to the present embodiment.

The control unit 33 calculates the transfer characteristics on the basis of a first audio signal and a second audio signal that corresponds to the first audio signal that is reproduced by each of the measurement earphones 10. The calculated transfer characteristics correspond to the difference between the first audio signal and the second audio signal. The first audio signal is an audio signal reproduced for the measurement of the transfer characteristics. The first audio signal may be a so-called sweep signal that gradually changes in frequency, for example, from a low frequency to a high frequency. The second audio signal is a first audio signal influenced by the transfer path from the measurement earphone 10 to the mic 20.

If described in detail, the control unit 33 first outputs a first audio signal stored in the storage unit 32 to the measurement earphone 10 to cause the measurement earphone 10 to reproduce the first audio signal. The mic 20 acquires a second audio signal that is an audio signal which is the first audio signal reproduced from the measurement earphone 10 and is derived from sound coming through the transfer path from the measurement earphone 10 to the mic 20. The control unit 33 then calculates the transfer characteristics on the basis of the first audio signal and the second audio signal. After that, the control unit 33 causes the storage unit 32 to store the calculated transfer characteristics.

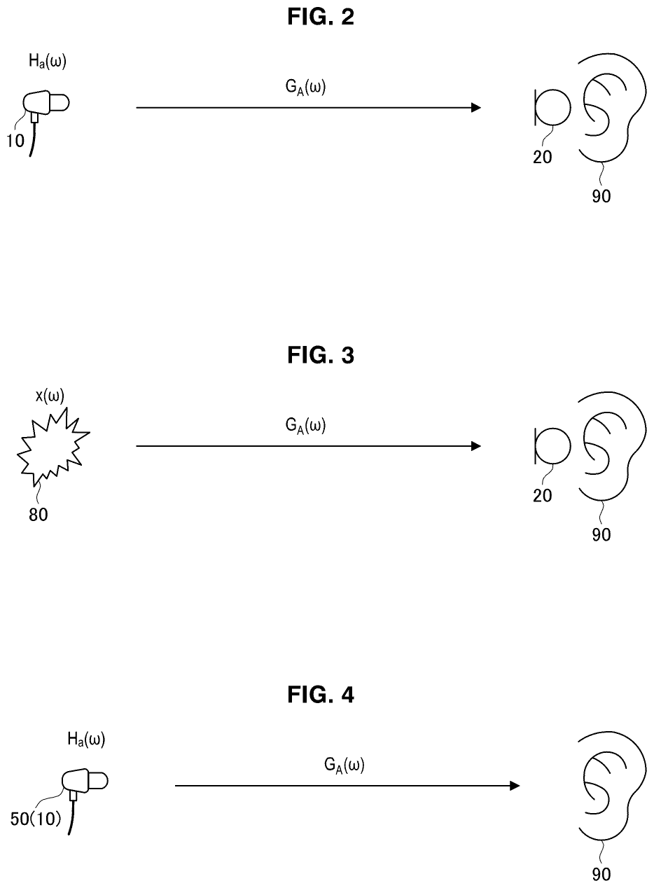

The measurement of the transfer characteristics will be described with reference to FIG. 2.

FIG. 2 is a diagram for describing the measurement of the transfer characteristics according to the present embodiment. As illustrated in FIG. 2, the transfer path from the measurement earphone 10 to the mic 20 has the measurement earphone 10 and an auricle 90 of the user A wearing the measurement earphone 10 and the mic 20. The transfer characteristics to be measured are therefore expressed by the following expression.

$$\begin{matrix}[ Math . 1 ] & \\ {G}_{m} ( ω ) = {G}_{A} ( ω ) {H}_{a} ( ω ) & ( 1 )\end{matrix}$$

Here, Gₘ(ω) represents the transfer characteristics. Hₐ(ω) represents the acoustic characteristics of the measurement earphone 10. It should be noted that the acoustic characteristics herein are, for example, magnitude-frequency characteristics. In addition, phase-frequency characteristics, phase delay characteristics, group delay characteristics, and the like may be adopted. G_{A}(ω) represents the acoustic characteristics of the auricle 90 of the user A. ω represents an angular frequency.

### (2) Binaural Recording

The sound-recording processing device 30 performs binaural recording. Binaural recording is performed with the mics 20 worn on a user.

If described in detail, each of the mics 20 acquires a third audio signal derived from sound coming from a sound source that is a target of binaural recording. The control unit 33 then generates a fourth audio signal by correcting the acquired audio signal on the basis of the transfer characteristics measured in advance. Specifically, the control unit 33 generates the fourth audio signal by convolving the inverse characteristics of the transfer characteristics measured in advance with the third audio signal. This configuration makes it possible to increase the quality of binaural reproduction as described below. After that, the control unit 33 causes the storage unit 32 to store the generated fourth audio signal. The fourth audio signal is binaurally recorded content. In this way, according to the present embodiment, it is possible to make a correction for increasing the quality of binaural reproduction in advance at the time of binaural recording.

It is desirable that a user who wears the mics 20 at the time of binaural recording and a user who wears the measurement earphones 10 and the mics 20 at the time of the measurement of the transfer characteristics are the same. Further, it is desirable that the disposition of the mics 20 at the time of binaural recording and the disposition of the mics 20 at the time of the measurement of the transfer characteristics be the same. In that case, it is possible to maximize the correction effects and increase the quality of binaural reproduction. Needless to say, a user who wears the mics 20 at the time of binaural recording and a user who wears the measurement earphones 10 and the mics 20 at the time of the measurement of the transfer characteristics may be different. It will be assumed below that binaural recording is performed with the user A wearing the mics 20 at the same disposition as the disposition at the time of the measurement of the transfer characteristics.

Binaural recording will be described with reference to FIG. 3.

FIG. 3 is a diagram for describing binaural recording according to the present embodiment. As illustrated in FIG. 3, the transfer path from a sound source 80 that is a target of binaural recording to the mic 20 has the auricle 90 of the user A wearing the mic 20. A third audio signal to be acquired by the mic 20 is therefore expressed by the following expression.

$$\begin{matrix}[ Math . 2 ] & \\ {y}_{r e c} ( ω ) = {G}_{A} ( ω ) x ( ω ) & ( 2 )\end{matrix}$$

Here, y_{rec}(ω) represents the third audio signal. x(ω) represents an audio signal (also referred to as a sound source signal below) derived from sound generated from the sound source 80.

The control unit 33 generates a fourth audio signal by convolving the inverse characteristics of the transfer characteristics Gₘ(ω) measured in advance with the third audio signal y rec (ω). The fourth audio signal is expressed by the following expression.

$$\begin{matrix}[ Math . 3 ] & \\ {y}^{′} ( ω ) = {y}_{r e c} ( ω ) {G}_{m}^{- 1} ( ω ) = {G}_{A} ( ω ) {G}_{A}^{- 1} ( ω ) {H}_{a}^{- 1} ( ω ) x ( ω ) = {H}_{a}^{- 1} ( ω ) x ( ω ) & ( 3 )\end{matrix}$$

Here, y′(ω) represents the fourth audio signal. Gₘ⁻¹(ω) represents the inverse characteristics of the transfer characteristics Gₘ(ω). Hₐ⁻¹(ω) represents the inverse characteristics of the acoustic characteristics Hₐ(ω) of the measurement earphone 10.

As indicated in Expression (3), the fourth audio signal y′(ω) is the sound source signal x(ω). In the sound source signal x(ω), the acoustic characteristics G_{A}(ω) of the auricle 90 of the user A are cancelled. In addition, the inverse characteristics Hₐ⁻¹(ω) of the acoustic characteristics Hₐ(ω) of the measurement earphone 10 are convolved with the sound source signal x(ω) in advance. This makes it possible to increase the quality of binaural reproduction without making a correction for cancelling the acoustic characteristics G_{A}(ω) of the auricles 90 of the user A or cancelling the acoustic characteristics Hₐ(ω) of the measurement earphones 10 at the time of binaural reproduction.

The correction is not necessary at the time of binaural reproduction. This makes it possible to significantly reduce the processing load on the whole of a system that distributes binaurally recorded content to a large number of reproduction processing devices 40 in real time. In addition, in a case where the correction is made at the time of binaural reproduction, it may be necessary to distribute metainformation for the correction along with the binaurally recorded content. In this regard, according to the present embodiment, it is possible to eliminate the necessity to distribute the metainformation for the correction. This makes it possible to significantly reduce even the communication load. It should be noted that the metainformation for the correction includes the acoustic characteristics G_{A}(ω) of the auricle 90 of the user A, the acoustic characteristics Hₐ(ω) of the measurement earphone 10, and the like.

In addition, according to the present embodiment, binaural recording is performed with the mics 20 worn on the human user A. This makes it possible to perform simple and high-quality binaural recording in a variety of use cases in comparison with binaural recording performed by using a dummy head. For example, it is possible to perform binaural recording with the mics 20 worn on a user who is capturing a moving image while moving with a camera in a hand. In addition, it is also possible for a user to perform binaural recording and monitor the binaural recording (i.e., check sound to be recorded) at the same time.

### (3) Binaural Reproduction

The reproduction processing device 40 performs binaural reproduction. Binaural reproduction is performed with the reproduction earphones 50 worn on a user. Each of the reproduction earphones 50 is disposed at the auricle of the user. As an example, the reproduction earphone 50 may be disposed at the cavum concha.

If described in detail, the control unit 43 causes the reproduction earphone 50 to reproduce a fourth audio signal stored by the storage unit 32. For example, the control unit 43 controls the communication unit 41 to cause the communication unit 41 to receive the fourth audio signal stored by the storage unit 32. Subsequently, the control unit 43 causes the storage unit 42 to store the fourth audio signal received by the communication unit 41. After that, the control unit 43 outputs the fourth audio signal stored by the storage unit 42 to the reproduction earphone 50 and causes the reproduction earphone 50 to reproduce the fourth audio signal. This allows a user wearing the reproduction earphones 50 to listen to the binaurally recorded sound.

A user who wears the mics 20 at the time of binaural recording and a user who wears the reproduction earphones 50 at the time of binaural reproduction may be the same. That is, binaural reproduction may be performed with the user A wearing the reproduction earphones 50. Meanwhile, a user who wears the mics 20 at the time of binaural recording and a user who wears the reproduction earphones 50 at the time of binaural reproduction may be different. That is, binaural reproduction may be performed with a user B wearing the reproduction earphones 50. The user B is different from the user A. The user B is an example of a second user according to the present embodiment.

In addition, the measurement earphones 10 and the reproduction earphones 50 may be the same. Meanwhile, the measurement earphones 10 and the reproduction earphones 50 may be different.

The following describes sounds to which a user listens when binaurally recorded content is binaurally reproduced in three types of reproduction environments.

### -First Reproduction Environment

A first reproduction environment is a reproduction environment in which the measurement earphones 10 and the reproduction earphones 50 are the same and the reproduction earphones 50 are worn by the user A. Binaural reproduction in the first reproduction environment will be described with reference to FIG. 4.

FIG. 4 is a diagram for describing binaural reproduction according to the present embodiment. As illustrated in FIG. 4, the transfer path from the reproduction earphone 50 that is the same as the measurement earphone 10 to an eardrum of the user A has the auricle 90 of the user A wearing the reproduction earphone 50. An audio signal indicating sound to which the user A listens is therefore expressed by the following expression.

$$\begin{matrix}[ Math . 4 ] & \\ {y}_{rep} ( ω ) = {G}_{A} ( ω ) {H}_{a} ( ω ) {y}^{′} ( ω ) = {G}_{A} ( ω ) x ( ω ) = {y}_{rec} ( ω ) & ( 4 )\end{matrix}$$

Here, yᵣₑₚ(ω) represents an audio signal indicating sound to which a user wearing the reproduction earphone 50, that is, the user A listens. Hₐ(ω) represents the acoustic characteristics of the reproduction earphone 50 that is the same as the measurement earphone 10.

As indicated in Expression (4), it is possible for the user A to listen to the third audio signal y_{rec}(ω). That is, it is possible for the user A to listen to the same sounds as the sounds at the time of binaural recording. In this way, it is possible to increase the quality of binaural reproduction.

### -Second Reproduction Environment

A second reproduction environment is a reproduction environment in which the measurement earphones 10 and the reproduction earphones 50 are the same and the reproduction earphones 50 are worn by the user B different from the user A.

In this reproduction environment, the transfer path from the reproduction earphone 50 that is the same as the measurement earphone 10 to an eardrum of the user B has the auricle 90 of the user B wearing the reproduction earphone 50. An audio signal indicating sound to which the user B listens is therefore expressed by the following expression.

$$\begin{matrix}[ Math . 5 ] & \\ {y}_{rep} ( ω ) = {G}_{B} ( ω ) {H}_{a} ( ω ) {y}^{′} ( ω ) = {G}_{B} ( ω ) x ( ω ) & ( 5 )\end{matrix}$$

Here, yᵣₑₚ(ω) represents an audio signal indicating sound to which a user wearing the reproduction earphone 50, that is, the user B listens. Hₐ(ω) represents the acoustic characteristics of the reproduction earphone 50 that is the same as the measurement earphone 10. G_{B}(ω) represents the acoustic characteristics of the auricle 90 of the user B.

Expression (2) shows that the audio signal y_{rec}(ω) indicating each of sounds to which the user A listens at the time of binaural recording is obtained by convolving the acoustic characteristics G_{A}(ω) of the auricle 90 of the user A with the sound source signal x(ω). In contrast, Expression (5) shows that the audio signal yᵣₑₚ(ω) indicating each of sounds to which the user B listens at the time of binaural reproduction is obtained by convolving the acoustic characteristics G_{B}(ω) of the auricle 90 of the user B with the sound source signal x(ω). That is, in the place of binaural reproduction, the user B can listen to an audio signal indicating each of sounds to which the user B is to listen in a case where binaural recording was performed with the user B wearing the mics 20 instead of the user A. In this way, it is possible for the user B to listen to sounds that make the user B feel as if the user B was present in the place of binaural recording instead of the user A. In this way, it is possible to increase the quality of binaural reproduction.

The binaurally recorded sound source signals x(ω) may, however, include the influence of acoustic characteristics specific to the user A in addition to the acoustic characteristics of the auricles 90 of the user A. Such acoustic characteristics include acoustic characteristics caused by physical characteristics of the user A other than the auricles 90. The audio signal yᵣₑₚ(ω) indicating each of sounds to which the user B listens includes the influence of acoustic characteristics specific to the other user A. This may impair aural naturalness.

However, in a case where binaural recording is performed with the mics 20 worn on the ears of a human, it is possible to increase the quality of binaural reproduction in comparison with binaural recording performed with the mics 20 worn on a dummy head. This is because, in a case where binaural recording is performed with the mics 20 worn on a dummy head, the audio signal yᵣₑₚ(ω) indicating each of sounds to which the user B listens includes the acoustic characteristics of the dummy head. In that case, the sound reflection coefficient different from that of human skin and the influence of a structure different from a human body impair aural naturalness.

### -Third Reproduction Environment

A third reproduction environment is a reproduction environment in which the measurement earphones 10 and the reproduction earphones 50 are different and the reproduction earphones 50 are worn by the user B different from the user A.

In this reproduction environment, the transfer path from the reproduction earphone 50 that is different from the measurement earphone 10 to an eardrum of the user B has the auricle 90 of the user B wearing the reproduction earphone 50. An audio signal indicating sound to which the user B listens is therefore expressed by the following expression.

$$\begin{matrix}[ Math . 6 ] & \\ \begin{matrix}{y}_{rep} ( ω ) = {G}_{B} ( ω ) {H}_{n} ( ω ) {y}^{′} ( ω ) \\ = {G}_{B} ( ω ) \frac{{H}_{n} ( ω )}{{H}_{a} ( ω )} x ( ω )\end{matrix} & ( 6 )\end{matrix}$$

Here, yᵣₑₚ(ω) represents an audio signal indicating sound to which a user wearing the reproduction earphone 50, that is, the user B listens. Hₙ(ω) represents the acoustic characteristics of the reproduction earphone 50 that is different from the measurement earphone 10. G_{B}(ω) represents the acoustic characteristics of the auricle 90 of the user B.

Expression (6) shows that the user B listens to sounds each obtained by convolving acoustic characteristics Hₙ(ω)/Hₐ(ω) corresponding to the difference between the measurement earphone 10 and the reproduction earphone 50 with an audio signal indicating each of sounds to which the user B listens in the second reproduction environment described above. That is, the user B can listen to sounds in the place of binaural reproduction similar to sounds to which the user B is to listen in a case where binaural recording was performed with the user B wearing the mics 20 instead of the user A. An increase in the quality of binaural reproduction is therefore expected.

### (4) Flow of Processing

### Measurement of Transfer Characteristics

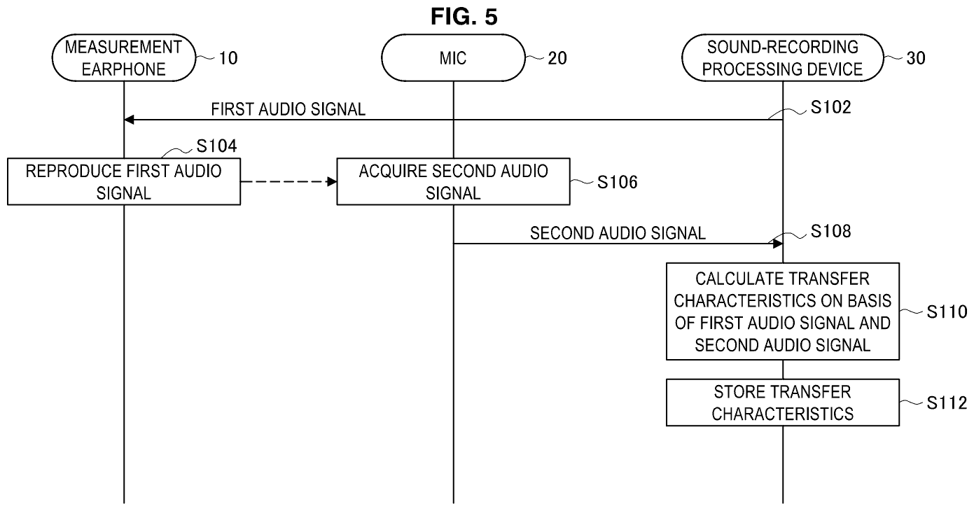

A flow of processing related to the measurement of transfer characteristics according to the present embodiment will be described below with reference to FIG. 5. FIG. 5 is a sequence diagram illustrating an example of a flow of processing related to the measurement of the transfer characteristics executed by the signal processing system 1 according to the present embodiment. The measurement earphone 10, the mic 20, and the sound-recording processing device 30 are involved in this sequence.

As illustrated in FIG. 5, the sound-recording processing device 30 first outputs a first audio signal to the measurement earphone 10 (step S102).

Subsequently, the measurement earphone 10 reproduces the inputted first audio signal (step S104)

Next, the mic 20 acquires a second audio signal (step S106). The second audio signal is an audio signal that is the first audio signal reproduced from the measurement earphone 10 and is derived from sound reaching the mic 20.

Subsequently, the mic 20 outputs the acquired second audio signal to the sound-recording processing device 30 (step S108).

Next, the sound-recording processing device 30 calculates the transfer characteristics on the basis of the first audio signal and the second audio signal (step S110).

The sound-recording processing device 30 then stores the calculated transfer characteristics (step S112).

### -Binaural Recording and Binaural Reproduction

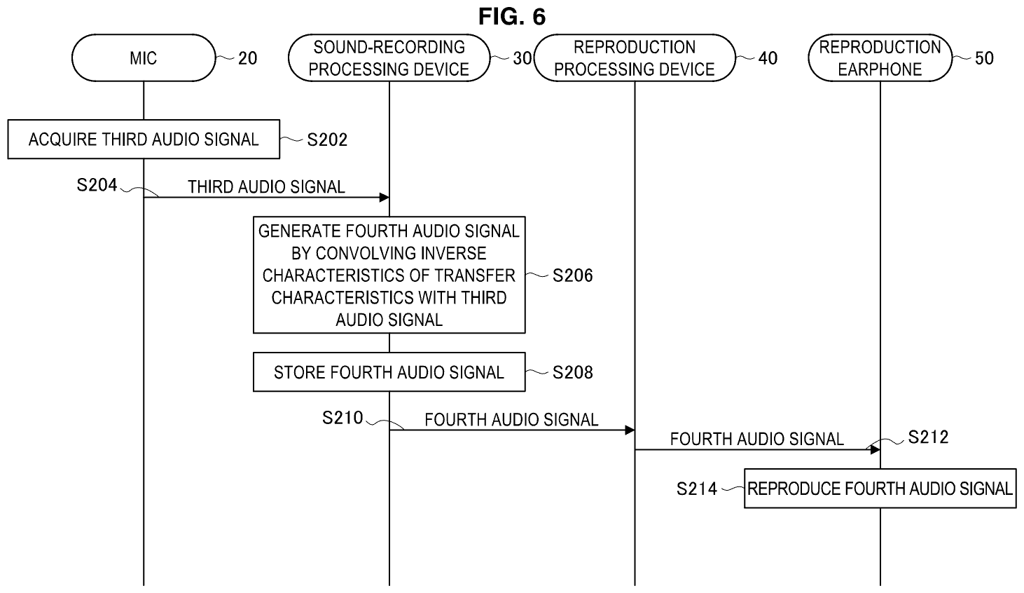

A flow of processing related to binaural recording and binaural reproduction according to the present embodiment will be described below with reference to FIG. 6. FIG. 6 is a sequence diagram illustrating an example of a flow of processing related to binaural recording and binaural reproduction executed by the signal processing system 1 according to the present embodiment. The mic 20, the sound-recording processing device 30, the reproduction processing device 40, and the reproduction earphone 50 are involved in this sequence.

As illustrated in FIG. 6, the mic 20 first acquires a third audio signal coming from a sound source that is a target of binaural recording (step S202).

Subsequently, the mic 20 outputs the acquired third audio signal to the sound-recording processing device 30 (step S204).

Next, the sound-recording processing device 30 generates a fourth audio signal by convolving the inverse characteristics of the transfer characteristics with the third audio signal (step S206).

Subsequently, the sound-recording processing device 30 stores the generated fourth audio signal (step S208).

The processing described above is processing related to binaural recording. Processing related to binaural reproduction will be described below.

The sound-recording processing device 30 transmits the stored fourth audio signal to the reproduction processing device 40 (step S210). For example, the sound-recording processing device 30 transmits the fourth audio signal in response to a request from the reproduction processing device 40.

Next, the reproduction processing device 40 outputs the received fourth audio signal to the reproduction earphone 50 (step S212).

The reproduction earphone 50 then reproduces the inputted fourth audio signal (step S214).

### 3. Supplementary Information

Heretofore, preferred embodiments of the present disclosure have been described in detail with reference to the appended drawings, but the present disclosure is not limited thereto. It should be understood by those skilled in the art that various changes and alterations may be made without departing from the spirit and scope of the appended claims.

### 3.1. First Modification Example

The present modification example is an example in which a correction for the third reproduction environment in which the measurement earphones 10 and the reproduction earphones 50 are different is made at the time of binaural recording. Points specific to the present modification example will be described below and the points common to those of the embodiment described above will not be described.

### (1) Measurement of Transfer Characteristics

The control unit 33 measures the transfer characteristics as in the embodiment described above. Further, the control unit 33 measures the acoustic characteristics of the measurement earphones 10 and the acoustic characteristics of the reproduction earphones 50. It is possible to measure the acoustic characteristics of the measurement earphones 10 in a free space such as an anechoic room. Similarly, it is possible to measure the acoustic characteristics of the reproduction earphones 50 in a free space such as an anechoic room.

### (2) Binaural Recording

The control unit 33 generates a fourth audio signal as in the embodiment described above. Further, the control unit 33 generates a fifth audio signal by correcting the fourth audio signal on the basis of the acoustic characteristics of each of the measurement earphones 10 and the acoustic characteristics of each of the reproduction earphones 50 measured in advance. Specifically, the control unit 33 generates the fifth audio signal by convolving the acoustic characteristics of the measurement earphone 10 and the inverse characteristics of the acoustic characteristics of the reproduction earphone 50 with the fourth audio signal. This configuration makes it possible to increase the quality of binaural reproduction in the third reproduction environment as described below. After that, the control unit 33 causes the storage unit 32 to store the generated fifth audio signal. The fifth audio signal is binaurally recorded content. In this way, according to the present modification example, it is possible to make a correction for increasing the quality of binaural reproduction in the third reproduction environment in advance at the time of binaural recording.

The fifth audio signal is expressed by the following expression.

$$\begin{matrix}[ Math . 7 ] & \\ {y}^{″} ( ω ) = {y}^{′} ( ω ) \times \frac{{H}_{a} ( ω )}{{H}_{n} ( ω )} = {y}_{r e c} ( ω ) {G}_{m}^{- 1} \frac{{H}_{a} ( ω )}{{H}_{n} ( ω )} = {G}_{A} ( ω ) {G}_{A}^{- 1} ( ω ) {H}_{a}^{- 1} ( ω ) \frac{{H}_{a} ( ω )}{{H}_{n} ( ω )} x ( ω ) = \frac{1}{{H}_{n} ( ω )} x ( ω ) & ( 7 )\end{matrix}$$

Here, y″(ω) represents the fifth audio signal. y′(ω) represents the fourth audio signal. Hₐ(ω) represents the acoustic characteristics of the measurement earphone 10. 1/Hₙ(ω) represents the inverse characteristics of the acoustic characteristics Hₙ(ω) of the reproduction earphone 50.

As indicated in Expression (7), the fifth audio signal y″(ω) is the sound source signal x(ω). In the sound source signal x(ω), the acoustic characteristics G_{A}(ω) of the auricle 90 of the user A and the acoustic characteristics Hₐ(ω) of the measurement earphone 10 are cancelled. In addition, the inverse characteristics 1/Hₙ(ω) of the acoustic characteristics Hₙ(ω) of the reproduction earphone 50 are convolved with the sound source signal x(ω) in advance. This makes it possible to increase the quality of binaural reproduction in the third reproduction environment without making a correction for cancelling the acoustic characteristics G_{A}(ω) of the auricles 90 of the user A or cancelling the acoustic characteristics Hₙ(ω) of the reproduction earphones 50 at the time of binaural reproduction.

### (3) Binaural Reproduction

The control unit 43 causes the reproduction earphone 50 to reproduce a fifth audio signal stored by the storage unit 32. For example, the control unit 43 controls the communication unit 41 to cause the communication unit 41 to receive the fifth audio signal stored by the storage unit 32. Subsequently, the control unit 43 causes the storage unit 42 to store the fifth audio signal received by the communication unit 41. After that, the control unit 43 outputs the fifth audio signal stored by the storage unit 42 to the reproduction earphone 50 and causes the reproduction earphone 50 to reproduce the fifth audio signal. This allows a user wearing the reproduction earphones 50 to listen to the binaurally reproduced sound.

In a case where the fifth audio signal is reproduced in the third reproduction environment, an audio signal indicating sound to which the user B listens is expressed by the following expression.

$$\begin{matrix}[ Math . 8 ] & \\ \begin{matrix}{y}_{rep} ( ω ) = {G}_{B} ( ω ) {H}_{n} ( ω ) {y}^{″} ( ω ) \\ = {G}_{B} ( ω ) x ( ω )\end{matrix} & ( 8 )\end{matrix}$$

Expression (8) shows that the user B listens to the same sound as each of the sounds to which the user B listens in the second reproduction environment. That is, it is possible to avoid a decrease in the quality of binaural reproduction in the third reproduction environment in the present modification example while the quality of binaural reproduction decreases by the difference between the measurement earphones 10 and the reproduction earphones 50 in the embodiment described above. In this way, it is possible for the user B to listen to sounds that make the user B feel as if the user B was present in the place of binaural recording even in the third reproduction environment. The same applies to the first reproduction environment and the second reproduction environment. In this way, it is possible to increase the quality of binaural reproduction.

### (4) Flow of Processing

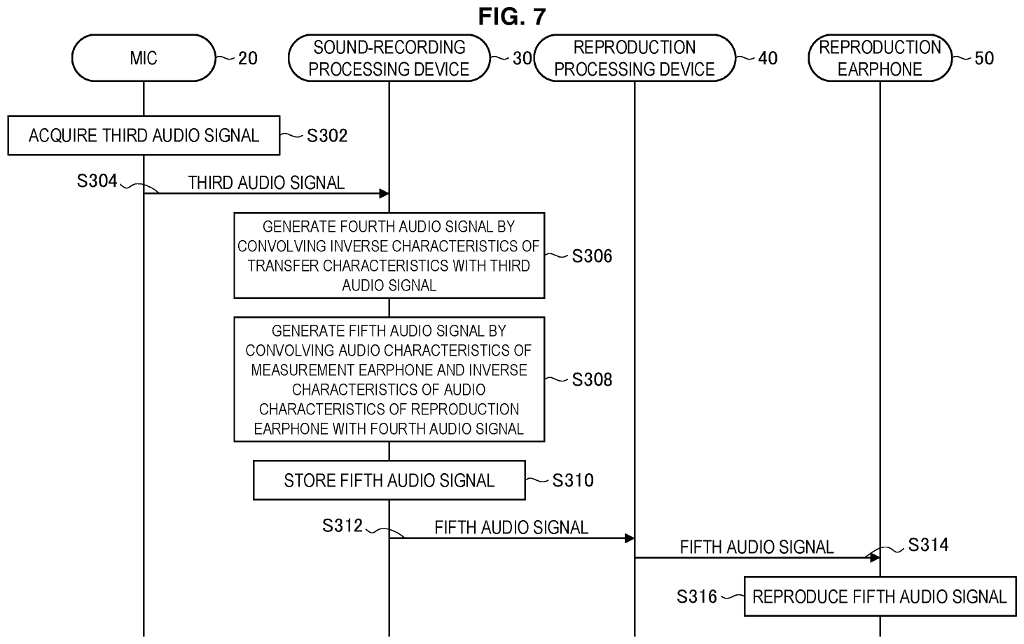

A flow of processing related to binaural recording and binaural reproduction according to the present modification example will be described below with reference to FIG. 7. FIG. 7 is a sequence diagram illustrating an example of a flow of processing related to binaural recording and binaural reproduction executed by the signal processing system 1 according to the present modification example. The mic 20, the sound-recording processing device 30, the reproduction processing device 40, and the reproduction earphone 50 are involved in this sequence.

As illustrated in FIG. 7, the mic 20 first acquires a third audio signal derived from sound coming from a sound source that is a target of binaural recording (step S302).

Subsequently, the mic 20 outputs the acquired third audio signal to the sound-recording processing device 30 (step S304).

Next, the sound-recording processing device 30 generates a fourth audio signal by convolving the inverse characteristics of the transfer characteristics with the third audio signal (step S306).

Subsequently, the sound-recording processing device 30 generates the fifth audio signal by convolving the acoustic characteristics of the measurement earphone 10 and the inverse characteristics of the acoustic characteristics of the reproduction earphone 50 with the fourth audio signal (step S308).

Next, the sound-recording processing device 30 stores the generated fifth audio signal (step S310).

The processing described above is processing related to binaural recording. Processing related to binaural reproduction will be described below.

The sound-recording processing device 30 transmits the stored fifth audio signal to the reproduction processing device 40 (step S312). For example, the sound-recording processing device 30 transmits the fifth audio signal in response to a request from the reproduction processing device 40.

Subsequently, the reproduction processing device 40 outputs the received fifth audio signal to the reproduction earphone 50 (step S314).

The reproduction earphone 50 then reproduces the inputted fifth audio signal (step S316).

### (5) Supplementary Information

Some types of reproduction earphones 50 may be used at the time of binaural reproduction. In that case, the sound-recording processing device 30 may generate a fifth audio signal for each of some types of reproduction earphones 50 that may be used at the time of binaural reproduction. The sound-recording processing device 30 may then store the fifth audio signal for each type of reproduction earphone 50. At the time of binaural reproduction, the sound-recording processing device 30 may transmit the fifth audio signal corresponding to each of the reproduction earphones 50 used for the binaural reproduction to the reproduction processing device 40. This configuration makes it possible to increase the quality of binaural reproduction even in a case where any type of reproduction earphones 50 is used for the binaural reproduction.

### 3.2. Hardware Configuration Example

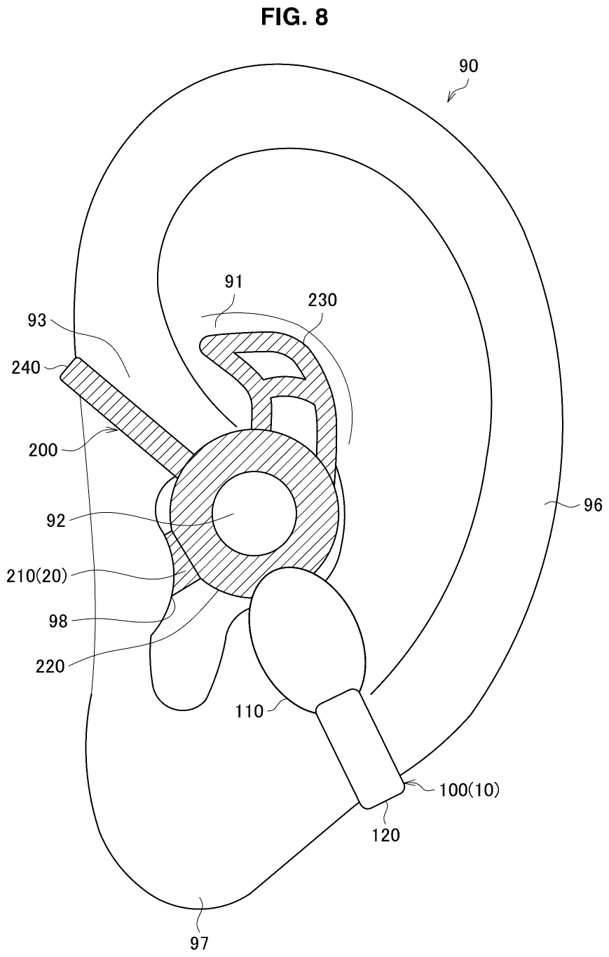

The measurement earphones 10 and the mics 20 may be implemented by various kinds of hardware. An example thereof will be described with reference to FIG. 8.

FIG. 8 is a diagram schematically illustrating an example of a hardware configuration of the measurement earphone 10 and the mic 20. As illustrated in FIG. 8, a headphone 100 serving as the measurement earphone 10 and a sound collection jig 200 including the mic 20 are worn on the auricle 90 of a user.

### (1) Headphone 100

The headphone 100 is a sound output device that reproduces an audio signal. The headphone 100 is an example of the measurement earphone 10. The headphone 100 is configured in the shape of a so-called ear cuff. The headphone 100 is worn by a user to cover a part of the sound collection jig 200 worn on the user. The headphone 100 includes a driver unit 110 and a frame 120.

The driver unit 110 is a device that converts an inputted audio signal to sound and emits the sound to the surrounding space.

The frame 120 is a member that holds the driver unit 110 at the auricle 90. The frame 120 is curved to pass by the outside of at least any of a helix 96 or an earlobe 97 from the front surface of the auricle 90 to the back surface of the auricle 90 when the headphone 100 is worn by a user. The driver unit 110 is connected to an end of the frame 120. The frame 120 then clamps the auricle 90 from the front surface of the auricle 90 and the back surface of the auricle 90 with the driver unit 110 connected to the end of the frame 120 and the other end of the frame 120.

### (2) Sound Collection Jig 200

The sound collection jig 200 includes an insertion unit 210 including the mic 20, a first frame 220, a second frame 230, and a third frame 240.

The insertion unit 210 is a member that is inserted to an external auditory canal 98 of a user. The insertion unit 210 is configured as a tubular body having a through hole that extends through the tubular body in the insertion direction. The mic 20 is then disposed inside the through hole of the insertion unit 210 with a gap provided between the mic 20 and the inner wall of the through hole. Once the insertion unit 210 is inserted to the external auditory canal 98 of a user, the mic 20 is disposed near the eardrum of the user. Moreover, sound coming from the outside world passes through the through hole to reach the eardrum of the user. This allows the user to clearly listen to ambient sound when wearing the sound collection jig 200.

The first frame 220 is a member configured in the shape of a ring. The first frame 220 abuts a cavum concha 92 of a user when the sound collection jig 200 is worn by the user. The first frame 220 is connected to the insertion unit 210.

The second frame 230 is a member configured in the shape of a lightened shark fin. The second frame 230 abuts a cymba concha 91 of a user when the sound collection jig 200 is worn by the user. The second frame 230 is connected to the first frame 220.

The third frame 240 is curved to pass by the outside of a helical crus 93 of a user from the front surface of the auricle 90 of the user to the back surface of the auricle 90 when the sound collection jig 200 is worn by the user. The third frame 240 is connected to the first frame 220.

### (3) Supplementary Information

The example of the hardware configuration of the measurement earphone 10 and the mic 20 has been described above. According to the examples described above, it is possible to dispose the measurement earphone 10 at the auricle 90 of a user while inserting the mic 20 to the external auditory canal 98 of the user and disposing the mic 20 near the eardrum. In addition, it is possible to measure the transfer characteristics and perform binaural recording with the external auditory canals 98 of the user kept open. Further, it is easier to dispose the mics 20 at the same position at the time of the measurement of the transfer characteristics and at the time of binaural recording because it is possible to measure the transfer characteristics and perform binaural recording with the devices worn. As a result, it is easier to maximize the correction effects and increase the quality of binaural reproduction.

It should be noted that the example has been described above in which the headphone 100 and the sound collection jig 200 are configured as different devices, but the present disclosure is not limited to this example. The headphone 100 and the sound collection jig 200 may be implemented as the same device. As an example, the first frame 220 may be provided with the driver unit 110. In other words, the measurement earphone 10 and the mic 20 may be mounted on the same device.

### 3.3. Network Configuration Example

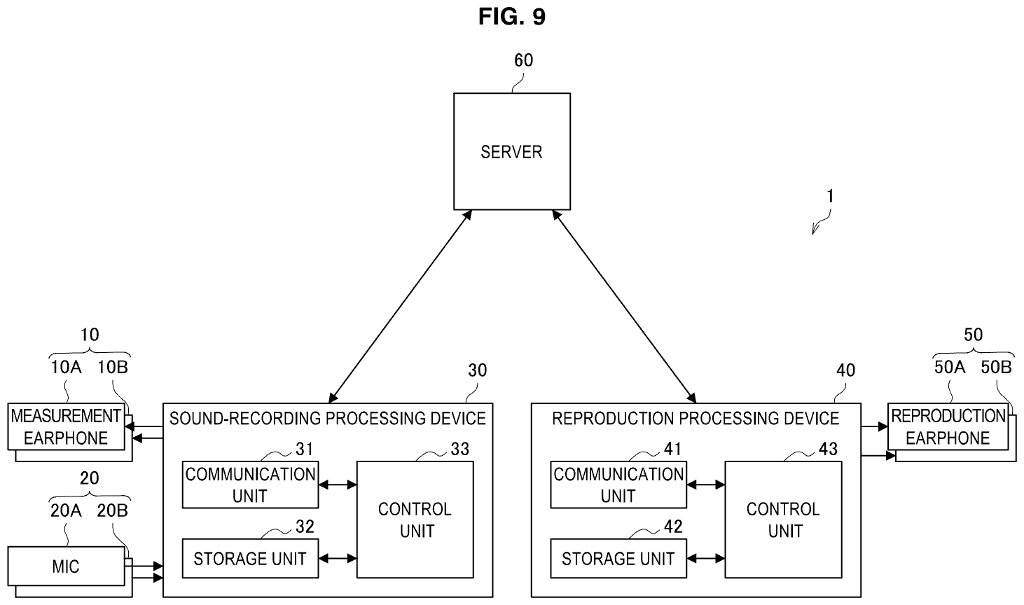

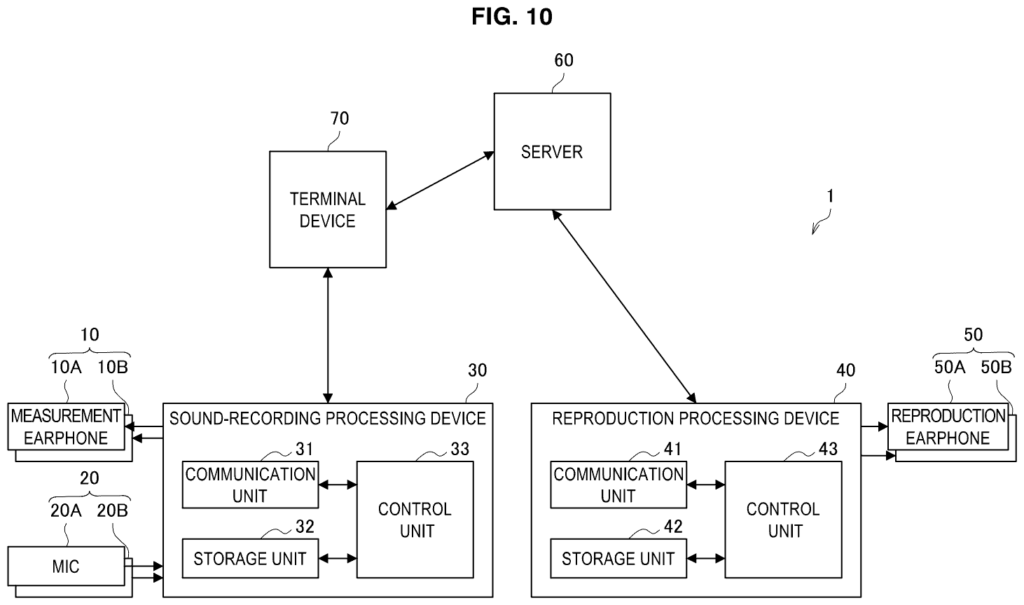

The example has been described above in which the sound-recording processing device 30 and the reproduction processing device 40 directly communicate with each other, but the present disclosure is not limited to this example. As described below with reference to FIGS. 9 and 10, communication between the sound-recording processing device 30 and the reproduction processing device 40 may be relayed by another device.

FIG. 9 is a diagram illustrating another example of the configuration of the signal processing system 1. As illustrated in FIG. 9, the signal processing system 1 may include a server 60 in addition to the devices illustrated in FIG. 1. The server 60 is an information processing device disposed in the Internet. The sound-recording processing device 30 and the reproduction processing device 40 may be connected through the server 60. For example, the sound-recording processing device 30 uploads binaurally recorded content to the server 60. The reproduction processing device 40 then downloads the binaurally recorded content from the server 60 and causes the reproduction earphones 50 to reproduce the downloaded content. Such a communication path may be used, for example, at the time of distributing the binaurally recorded content through the Internet in real time.

FIG. 10 is a diagram illustrating another example of the configuration of the signal processing system 1. As illustrated in FIG. 10, the signal processing system 1 may include the server 60 and a terminal device 70 in addition to the devices illustrated in FIG. 1. The server 60 is an information processing device disposed in the Internet. The terminal device 70 is an information processing device that is operated by a user. An example of the terminal device 70 is a smartphone or a tablet terminal. The sound-recording processing device 30 and the reproduction processing device 40 may be connected through the server 60 and the terminal device 70. For example, the sound-recording processing device 30 transmits binaurally recorded content to the terminal device 70. The terminal device 70 uploads the received binaurally recorded content to the server 60. The reproduction processing device 40 then downloads the binaurally recorded content from the server 60 and causes the reproduction earphones 50 to reproduce the downloaded content. Such a communication path may be used, for example, at the time of distributing the binaurally recorded content through the Internet net in real time.

The signal processing system 1 includes the terminal device 70, thereby making it possible to omit a function of communication with the server 60 from the sound-recording processing device 30. In addition, it is possible to make various kinds of settings and the like related to real-time distribution through the terminal device 70. This makes it possible to increase the convenience of the real-time distribution for a user. It should be noted that the terminal device 70 may include an imaging unit such as a camera. The terminal device 70 may then upload a moving image recorded in parallel with binaural recording to the server 60 along with audio signals obtained through the binaural recording. The reproduction processing device 40 may then download the moving image recorded in parallel with the binaural recording and reproduce the downloaded moving image along with the audio signals obtained through the binaural recording. In this case, it is possible to reproduce the moving image along with the binaurally recorded realistic sounds.

### 3.4. Others

The example has been described above in which the control unit 33 and the control unit 43 are mounted on different devices, but the present disclosure is not limited to this example. The control unit 33 and the control unit 43 may be mounted on the same device. That is, one information processing device including the control unit 33 and the control unit 43 may calculate the transfer characteristics, perform binaural recording, and perform binaural reproduction.

The example has been described above in which a correction is made at the time of binaural recording, but the present disclosure is not limited to this example. At least some of corrections may be made at the time of binaural reproduction instead of binaural recording. As an example, a correction based on the transfer characteristics measured in advance may be made by the reproduction processing device 40. As another example, a correction based on the acoustic characteristics of the measurement earphone 10 and the acoustic characteristics of the reproduction earphone 50 measured in advance may be made by the reproduction processing device 40. In addition, in a case where a correction is made at the time of binaural reproduction, the transfer characteristics may be measured after binaural recording. The same applies to the measurement of the acoustic characteristics of the measurement earphone 10 and the acoustic characteristics of the reproduction earphone 50.

The example has been described above in which the transfer characteristics are measured and binaural recording is performed with the measurement earphones 10 and/or the mics 20 worn on a human, but the present disclosure is not limited to this example. The transfer characteristics may be measured and binaural recording may be performed with the measurement earphones 10 and/or the mics 20 worn on a dummy head.

FIG. 1 illustrates the example in which the signal processing system 1 includes the two measurement earphones 10, the two mics 20, and the two reproduction earphones 50 for both respective ears, but the present disclosure is not limited to this example. The signal processing system 1 may include the one measurement earphone 10, the one mic 20, and the one reproduction earphone 50 for one of the ears. That is, the present disclosure is applicable to binaural recording/reproduction is performed for one of the ears in addition to binaural recording/reproduction for both of the ears.

Each of the devices described herein may be implemented as an individual device or some or all of the devices may be implemented as different devices. As an example, a device such as a server connected through a network or the like may have some of the functions of the sound-recording processing device 30 illustrated in FIG. 1. Specifically, at least part of information stored by the storage unit 32 or processing executed by the control unit 33 may be stored or executed by the server. As another example, a device such as a server connected through a network or the like may have some of the functions of the reproduction processing device 40 illustrated in FIG. 1. Specifically, at least part of information stored by the storage unit 42 or processing executed by the control unit 43 may be stored or executed by the server. As another example, the server 60 illustrated in FIG. 9 or 10 may be implemented not only by an individual device, but also by a plurality of devices. Specifically, the sound-recording processing device 30 and the reproduction processing device 40 may communicate with each other through a mesh network, that is, a plurality of devices. In addition, some of the functions of the sound-recording processing device 30 or the reproduction processing device 40 illustrated in FIG. 1 may be implemented in not only one device, but also two or more devices. For example, some of the functions of the sound-recording processing device 30 or the reproduction processing device 40 illustrated in FIG. 1 may be distributed to the plurality of devices in the mesh network.

The example has been described above in which the first acquisition unit used for the measurement of the transfer characteristics and the second acquisition unit used for binaural recording are implemented as the one mic 20, but the present disclosure is not limited to this example. The first acquisition unit and the second acquisition unit may be different. That is, different sound input devices may be used for the measurement of the transfer characteristics and binaural recording.

It is to be noted that the process by each device described herein may be achieved by software, hardware, or a combination of software and hardware. A program constituting software is stored in advance, for example, in a storage medium (more specifically, a non-transitory computer-readable storage medium) provided inside or outside each device. When executed by a computer that controls each device described herein, for example, each program is loaded into a RAM and executed by a processing circuit such as CPU. The storage medium is, for example, a magnetic disk, an optical disc, a magneto-optical disk, a flash memory, or the like. In addition, the computer program may be distributed over a network, instead, without using a storage medium. In addition, the computer may be an integrated circuit for a specific application such as an ASIC, a general-purpose processor that executes a function by reading a software program, a computer on a server used for cloud computing, or the like. In addition, the process by each device described herein may be performed by a plurality of computers in a distributed manner.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

### REFERENCE SIGNS LIST

1 signal processing system
10 (10A, 10B) measurement earphone
20 (20A, 20B) mic
30 sound-recording processing device
31 communication unit
32 storage unit
33 control unit
40 reproduction processing device
41 communication unit
42 storage unit
43 control unit
50 (50A, 50B) reproduction earphone
60 server
70 terminal device
80 sound source
90 auricle

1. A signal processing system comprising
a first control unit configured to
calculate a transfer characteristic corresponding to a difference between a first audio signal and a second audio signal that is acquired by a first acquisition unit, the first acquisition unit being configured to acquire an audio signal, the second audio signal corresponding to the first audio signal that is reproduced by a first reproduction unit, the first reproduction unit being configured to reproduce an audio signal, and
generate a fourth audio signal by convolving an inverse characteristic of the calculated transfer characteristic with a third audio signal that is acquired by a second acquisition unit.

2. The signal processing system according to claim 1, wherein the first control unit causes a storage unit to store the generated fourth audio signal.

3. The signal processing system according to claim 2, wherein the signal processing system further comprises a second control unit configured to cause a second reproduction unit to reproduce the fourth audio signal stored by the storage unit, the second reproduction unit being configured to reproduce an audio signal.

4. The signal processing system according to claim 1, wherein the first control unit generates a fifth audio signal by convolving a characteristic of the first reproduction unit and an inverse characteristic of a characteristic of a second reproduction unit with the fourth audio signal, the second reproduction unit being configured to reproduce an audio signal.

5. The signal processing system according to claim 4, wherein the first control unit causes a storage unit to store the generated fifth audio signal.

6. The signal processing system according to claim 5, wherein the signal processing system further comprises a second control unit configured to cause the second reproduction unit to reproduce the fifth audio signal stored by the storage unit.

7. The signal processing system according to claim 3, wherein the first control unit and the second control unit are mounted on different devices.

8. The signal processing system according to claim 3, wherein
the first acquisition unit is disposed near an eardrum of a first user,
the first reproduction unit is disposed at an auricle of the first user, and
the second reproduction unit is disposed at an auricle of a second user different from the first user.

9. The signal processing system according to claim 8, wherein the second reproduction unit is different from the first reproduction unit.

10. The signal processing system according to claim 8, wherein the second acquisition unit is disposed near the eardrum of the first user.

11. A signal processing method comprising:
reproducing a first audio signal by a first reproduction unit configured to reproduce an audio signal;
acquiring a second audio signal by a first acquisition unit configured to acquire an audio signal, the second audio signal corresponding to the first audio signal that is reproduced by the first reproduction unit;
calculating a transfer characteristic corresponding to a difference between the first audio signal and the second audio signal;
acquiring a third audio signal by a second acquisition unit; and
generating a fourth audio signal by convolving an inverse characteristic of the transfer characteristic with the third audio signal.

12. A non-transitory computer readable medium having a program stored therein, the program for causing a computer to function as
a first control unit configured to
calculate a transfer characteristic corresponding to a difference between a first audio signal and a second audio signal that is acquired by a first acquisition unit, the first acquisition unit being configured to acquire an audio signal, the second audio signal corresponding to the first audio signal that is reproduced by a first reproduction unit, the first reproduction unit being configured to reproduce an audio signal, and
generate a fourth audio signal by convolving an inverse characteristic of the calculated transfer characteristic with a third audio signal that is acquired by a second acquisition unit.
